(19) United States
(12) Patent Application Publication
(10) Pub. No.: US 2005/0083250 A1
(43) Pub. Date: Apr. 21, 2005

(54) Addressing cells of a display panel

(75) Inventor: Petrus Maria De Greef, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/502,517

(22) PCT Filed: Dec. 18, 2002
(86) PCT No.: PCT/IB02/05603

(30) Foreign Application Priority Data
Jan. 23, 2002 (EP) 02075278.8

(51) Int. Cl. G09G 3/28

(52) U.S. Cl. 345/60

(57) ABSTRACT

The present invention relates to a method and a device for addressing cells of a display panel, in particular discharge cells of a plasma display panel (PDP), each cell corresponding to a pixel in response to a video signal, wherein the addressing of those cells which are identified as being not active is skipped by an adaptive line skip unit (ALS).

### FIELD OF THE INVENTION

The present invention relates to a method and device for addressing cells of a display panel, in particular discharge cells of a plasma display panel, each cell corresponding to a pixel in response to a video signal. Further, the present invention relates to a display panel apparatus, in particular a plasma display panel apparatus, which comprises the mentioned device.

### BACKGROUND OF THE INVENTION

In recent years, a thin display apparatus has been requested in conjunction with an increase in size of the display panel. The plasma display panel (hereinafter simply referred to as “PDP”) is expected to become one of the most important display devices of the next generation which replaces the conventional cathode ray tube, because the PDP can easily realize reduction of thickness and weight of the panel and the provision of a flat screen shape and a large screen surface.

In the PDP that makes a surface discharge, a pair of electrodes is formed on an inner surface of a front glass substrate and a rare gas is filled within the panel. When a voltage is applied across the electrodes, a surface discharge occurs at the surface of a protection layer and a dielectric layer formed on the electrode surface, thereby generating ultraviolet rays. Fluorescent materials of the three primary colors red, green and blue are coated on an inner surface of a back glass substrate, and a color display is made by exciting the light emission from the fluorescent materials responsive to the ultraviolet rays.

The PDP comprises a plurality of column electrodes (address electrodes) and a plurality of row electrodes arranged so as to intersect the column electrodes. Each of the row electrodes pairs and the column electrodes are covered by a dielectric layer against a discharge space and have a structure such that a discharge cell corresponding to one pixel is formed at an intersecting point of the row electrode pair and the column electrode. Since the PDP provides a light emission display by using a discharge phenomenon, each of the discharge cells has only two states; a state where the light emission is performed and a state where it is not performed. A sub-field method is used to provide a halftone luminance display by the PDP. In the sub-field method, a display period of one field is divided into N sub-fields, a light emitting period having a duration period corresponding to a weight of each bit digit of the pixel data (N bits) is allocated every sub-field, and the light emission driving is performed.

The discharge is achieved by adjusting voltages between the column and row electrodes of a cell composing a pixel. The amount of discharged light changes to adjust the number of discharges in the cell. The overall screen is obtained by driving in a matrix type a write pulse for inputting a digital video signal to the column and row electrodes of the respective cells, a scan pulse for scanning a sustain pulse for sustaining discharge, and an erase pulse for terminating discharge of a discharged cell. Also, a gray scale is implemented by differentiating the number of discharges of each cell for a predetermined time required for displaying the entire picture.

The luminance of a screen is determined by the brightness for the case when each cell is driven to a maximum level. To increase the luminance, a driving circuit must be constructed such that the discharge time of a cell can be maintained as long as possible for a predetermined time required for forming a screen. The contrast, which is a difference in light and darkness, is determined by brightness and luminance of a background such as illumination. To increase the contrast, the background must be dark and the luminance thereof must be increased.

In common PDP display systems, a frame or field of a video signal information is displayed as a set of subfields. The subfields are often driven according the Address Display Separated (ADS) driving scheme. Each subfield has its own address, sustain and erase period. The erase period produces a small quantity of light on the complete display area Active addressing of a pixel-element creates one light-flash in the addressed pixel-element. Only the sustain-period generates light on request, controlled by a number of sustain-pulses. While only the sustain-period generates useful light, the time for addressing and erasing should be minimized in order to allow the display to generate more light.

For each subfield, each line of the display panel has to be addressed individually, i.e. each line at a time. This costs a lot of time, which consequently can not be used for sustaining. A considerable amount of time is needed to create sufficient sustain-pulses in plasma display panels in order to achieve a high peak brightness comparable to that of conventional cathode ray tubes.

Other options to increase the peak brightness could be achieved by the provision of shorter erase pulses, shorter line-address time and/or shorter sustain-pulses. However, these measures have a negative impact on the panel performance. When reducing the number of subfields per frame, peak-brightness is exchanged with color-depth.

The number of sustain-pulses per frame can increase by reducing the number of lines per frame which need to be addressed. The simplest way of doing this is by providing a display with a small number of lines which however results in a low resolution. Further, only a small number of subfields can be provided which however results in a low color-depth. Moreover, two lines can be addressed at a time (dual scan) which however is an expensive measure due to the need of extra drivers.

Alternatively, so-called interlaced images can be displayed. This method is used in a plasma display panel as disclosed in U.S. Pat. No. 6,232,935 B1. In this prior art, a parallel driving method is provided which is known to have better brightness characteristics than a separate driving method in which the addressing is separate from the discharge sustaining, in which the addressing and discharge sustaining are simultaneously performed. Periods between the discharge sustaining pulses applied to the scanning electrodes and the common electrodes are set as the address time slots periods, a plurality of data pulses are applied in the address time slots periods, and a number of common electrodes equal to the number of data pulses are wired as one common electrode group and are driven by the same signal, in order to solve the restrictions on the number of the horizontal scanning lines which can be scanned, which is a defect of conventional parallel drive methods.

Another technique using the addressing of two lines at a time is called Partial Line Doubling (PLD) which is used in a device as disclosed in EP 0 874 349 A1 for addressing a plasma display. This known device comprises a video processing circuit for processing the video data received, a correspondence memory for transcoding these data, a video memory for storing the transcoded data, and a control circuit for line drivers. The video memory is linked to column drivers in order to control the column addressing of the plasma panel on the basis of column control signals. The control circuit for the line drivers simultaneously selects at least two successive lines during the transmission by the column drivers of at least one of the bits of the column control signals relating to one of these lines.

### SUMMARY OF THE INVENTION

It is an object of the present invention to reduce the overall addressing time of a display panel, in particular a plasma display panel, without an essential deterioration of the image quality. To this end, the invention provides an addressing as defined by the independent claims. The dependent claims define advantageous embodiments.

By means of the present invention, the overall addressing time of display panels, in particular plasma display panels, can adaptively be reduced depending on the image-data. This is achieved by that in accordance with the present invention all cells that do not contain active data are skipped during the address circle. However, this reduction does not deteriorate the image quality, but the gained time can be used to increase the sustain level. With respect to the time benefit, it is not relevant which cells are skipped during addressing, while all gained time can contribute to a longer sustain-time e.g. for a frame.

So, with the present invention, less time is required for addressing when the image data allows this. The gained time can be particularly used to increase peak brightness and/or luminance. Further, the extra time might also be used to display extra gray-levels and, thus, to increase color-depth.

Therefore, the present invention provides the same kinds of benefits as the Partial Line Doubling method.

Since for panels with larger resolution the number of lines per frame which need to be addressed is very high, the present invention is particularly very important for such kind of panels.

Moreover, the present invention allows a feasible implementation and can also be used in combination with Partial Line Doubling and other address-time reduction algorithms.

Finally, the present invention leads to a reduction of costs in particular of a plasma display panel system since only a single scan is needed.

U.S. Pat. No. 6,151,000 A proposes to determine non-display areas that contain no image and not to scan these areas during a scanning period of a drive sequence for a plasma display panel. However, this prior art does not teach to skip the addressing of those cells that are identified as being not active.

Further advantageous embodiments of the present invention are defined in the dependent claims.

Preferably, those cells that are not active are identified before the skipping step is carried out. Further, before the identifying step, all the cells should be checked as to whether or not they are active.

Moreover, the addressing of a group of those cells that are identified as being not active can be skipped. In case each group is addressed during a predetermined group addressing period having a constant time interval for all groups, all groups with identical data can preferably be grouped and addressed during one group addressing period only. The grouping per se is known from EP 1 014 331 A1 which however does not teach the skipping of the addressing in accordance with the present invention.

In a preferred embodiment, wherein the cells are arranged as a matrix array and each cell is positioned at an intersection of a line and a column, the addressing of a line where all cells are not active is skipped. So, the new technique of the present invention can be described as Adaptive Line Skipping (ALS) for this embodiment where all lines that do not contain active data are skipped during the address circle. When the addressing of a line is skipped, the row-addressing of the X- and Y-drivers is shifted to the next line which results in a reduction of the line-address time. With respect to the time benefit, it is not relevant which lines are skipped during addressing, while all gained time can contribute to a longer sustain-time for the frame. Further, all lines with identical data can be grouped and addressed during one line addressing period.

In a further preferred embodiment wherein the video signal includes fields and each field is defined by a plurality of subfields, the addressing of parts of the subfields is skipped. In case of the grouping of groups or lines, all groups or lines with identical subfield-data should be grouped. With respect thereto, it is noted that the term “field” can also mean a frame, and the term “subfield” (SF) can also mean a subframe.

Moreover, a skip-table indicating all the cells which are identified as being not active can be set up before the skipping step and can be used in the skipping step to locate all cells to be skipped. In case of skipping the addressing of groups or lines, the skip-table indicates all the groups or lines including those cells only which are identified as being not active and is used in the skipping step to locate all groups or lines to be skipped.

Finally, the sustain-time can be determined by taking into account the extra time gained to be expected due to the skipping.

### BRIEF DESCRIPTION OF THE DRAWING

In the following, the present invention will be described in greater detail based on a preferred embodiment with reference to the accompanying drawings, in which:

FIG. 1 is a schematic block diagram of a PDP driving system; and

FIGS. 2a and 2b include flow diagrams schematically showing a process of skipping the addressing of a line by storing a line in a subfield memory or the number of that line in a skip-list (FIG. 2a) and by displaying a subfield (FIG. 2b).

### DESCRIPTION OF THE PREFERRED EMBODIMENT

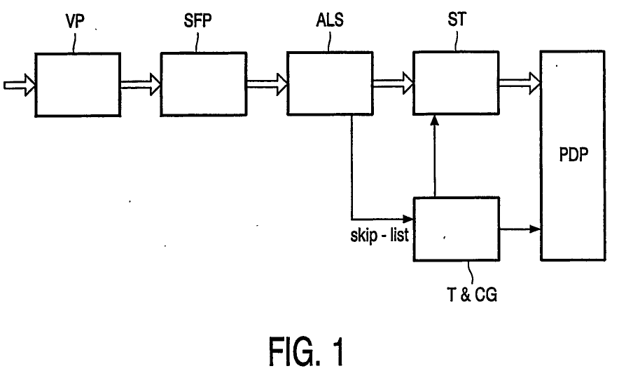

An implementation of the Adaptive Line Skipping (ALS) technique for a plasma display panel (PDP) according to a preferred embodiment of the present invention is shown as block diagram in FIG. 1. FIG. 1 shows a video processing unit VP, a sub-field processing unit SFP, an adaptive line skip unit ALS, a sub-field transpose unit ST, a plasma display panel PDP, and a timing & control generator T&CG receiving a skip-list from the adaptive line skip unit ALS.

All lines, which do not contain active subfield-data, must be identified when applying the Adaptive Line Skipping method. This identification can only be done when all subfield-data are known, i.e. after the subfield processing in the Sub-Field Processing module. When the information is gathered before the subfield transpose (frame-delay), the information can be forwarded towards the Timing & Control Generator module, which can expand the related sustain periods of this frame.

During the addressing of the subfields the identified lines-with-no-data will be skipped, reducing the total addressing period. With respect to the time benefit, it is not relevant which lines are skipped during addressing, while all gained time can contribute to a longer sustain-time for the frame.

During the identification process, for each line all active subfield-pixels are tested whether they are active. Once no active subfield-pixels are encountered, that line will be marked and later on skipped during the address cycle. The process generates a table comprising one bit per line per subfield and is carried out in the Adaptive Line Skip module.

This information is forwarded to the Timing & Control Generator module. Before the first subfield of the frame is displayed, the sustain-time per subfield is calculated. It takes into account all the extra time gained, due to the skipping of line-addresses. While this control is executed by a micro-controller, only software needs to be updated.

When the addressing cycle starts, the line-skip table is used to locate all lines to be skipped during the line-addressing cycle.

When the addressing of a line is skipped by means of the Adaptive Line Skip module, the row-addressing of the X- and Y-drivers is shifted to the next line, reducing line-address time from e.g. about 3 μs to a few clock periods. No modifications are required for the X- and Y-driver hardware provided in the plasma display panel PDP. However, the Timing & Control Generator module must generate some extra control sequences.

When the addressing of a line is skipped, the related column-data does not need to be transferred from the subfield-frame memory, which is used for transpose. This reduces the line-address time e.g. for WVGA panels from 852/16 clocks to a few clock periods. The Timing & Control Generator module will inform the Subfield Transpose module whether a line skip occurs. So, only a slight modification of the Subfield Transpose module is required.

The image of video and data-graphics application will not always have active content on all the lines of all generated subfields. This will be illustrated with some examples.

With data-graphics applications often only a set of colors from a pallet are used. These will use only a limited set of colors. In some cases a set of subfields may hardly contain any data, allowing ALS to gain addressing time.

Video-applications have an average image load of about 15% and subfields distributions may have unused subfield-combinations to reduce artifacts. So a lot of subfield pixels will be inactive.

For video application some specific scenes demand a high brightness to improve the perceived image quality. For example a dark scene with some sparkling lights requires sufficient gray-levels in dark areas (many subfields) and also sufficient peak brightness. In this case the power-supply and temperature will not be the limiting factors; only the limited sustain-time is the real constraint. These scenes however will have a lot of lines in the higher sub-fields inactive, providing extra time for better peak brightness.

Clear addressing schemes use an incremental pixel addressing technique, which can only turn off a primed pixel per frame. During the first few frames (least significant subfields) many pixels must remain on and need not be triggered yet, increasing the chance on a blank (skip) subfield-line. During the last few frames (most significant subfields) many pixels are already off and need not be triggered any more, also increasing the chance on a blank (skip) subfield-line.

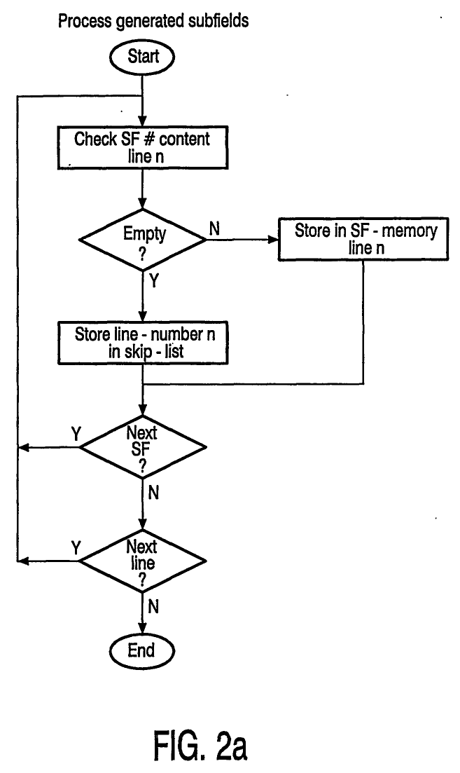

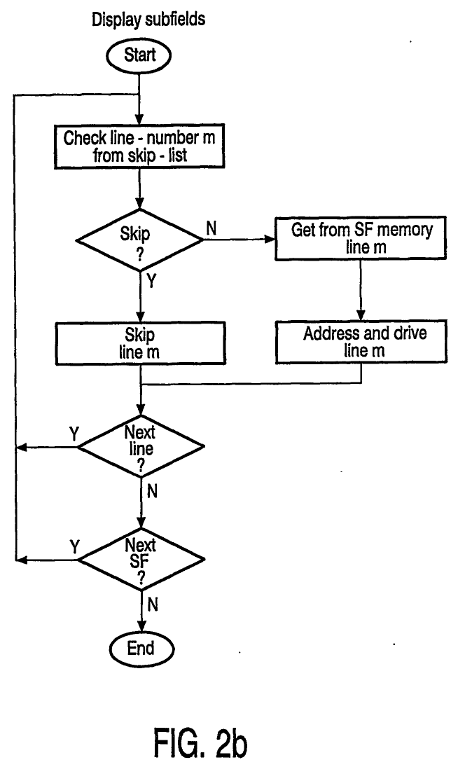

FIGS. 2a and 2b include flow diagrams schematically showing a process of skipping the addressing of a line as an example. FIG. 2a shows the processing of generated subfields wherein for a generated set of subfield-data the SF# contents of a line n are checked whether or not they are empty. When there are no active SF-data for a given SF#, the number of the line in question is stored in a skip-list; otherwise the SF-data are stored in an allocated SF-memory. This process is continued for all SF# over all lines.

The SF-memory is used in the transpose process carried out in the Subfield Transpose module, to change from SF-data per pixel to SF-data per SF#.

FIG. 2b shows the process of displaying the subfields. When the subfields are displayed, it is checked whether or not the active line of a given SF# can be skipped. When a line must be displayed, the SF-data is retrieved from the SF-memory and forwarded to the display. This process is again continued for all lines over all SF#.

Although the invention is described above with reference to an example shown in the attached drawing, it is apparent that the invention is not restricted to it, but can vary in many ways within the scope discloses in the attached claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A method for addressing cells of a display panel, each cell corresponding to a pixel in response to a video signal, characterized by the step of skipping the addressing of those cells which are identified as being not active.

2. The method according to claim 1, wherein the video signal includes fields and each field is defined by a plurality of subfields,
characterized in that said skipping step is carried out during the addressing of the subfields.

3. The method according to claim 2, characterized in that all groups with identical subfield-data are grouped.

4. The method according to claim 3, characterized in that all lines with identical subfield-data are grouped.

5. A device for addressing cells of a display panel each cell corresponding to a pixel in response to a video signal,
characterized by means for skipping the addressing of those cells which are identified as being not active.

6. The device according to claim 5, further characterized by means for identifying those cells which are not active.

7. The device according to claim 6, further characterized by means for checking all the cells as to whether or not they are active.

8. The device according to claim 5, characterized in that said skipping means is provided for skipping the addressing of a group of those cells which are identified as being not active.

9. The device according to claim 8, wherein each group is addressed during a predetermined group addressing period having a constant time interval for all groups, further characterized by means for grouping all groups having identical data and addressing them during one group addressing period.

10. The device according to claim 8, wherein the cells are arranged as a matrix array and each cell is positioned at an intersection of a line and a column,
characterized in that said skipping means are provided for skipping the addressing of a line where all cells are not active.

11. The device according to claim 9, characterized by means for grouping all lines with identical data and addressing them during one line addressing period.

12. The device according to claim 5, further characterized by means for setting up a skip-table indicating all the cells which are identified as being not active.

13. The device according to claim 12, characterized in that said skip-table indicates all the groups including those cells only which are identified as being not active.

14. The device according to claim 12, characterized in that said skip-table indicates all the lines including those cells only which are identified as being not active.

15. The device according to claim 5, for addressing and driving discharge cells of a plasma display panel, the device further comprising
means for applying a sustain-level signal to cause a sustaining discharge in a discharge cell for emitting light therefrom, and
means for determining the sustain-time by taking into account the extra time gained to be expected due to the operation of said skipping means.

16. A display panel apparatus, in particular a plasma display panel apparatus, comprising the device according to claim 5.
